(19) United States
(12) Patent Application Publication
(10) Pub. No.: US 2009/0100174 A1
(43) Pub. Date: Apr. 16, 2009

(54) Method and system for automatic polling of multiple device types

(76) Inventors: Sushma Annareddy, Milford, MA (US); Gary Cunha, Medway, MA (US); Christopher Bates, Ashland, MA (US); Christopher Oktota, Medford, MA (US)

Correspondence Address: ARRIS INTERNATIONAL, INC, 3871 LAKEFIELD DRIVE, SUWANEE, GA, 30024, US

(21) Appl. No.: 12/205,893

(22) Filed: Sep. 7, 2008

Related U.S. Application Data
(60) Provisional application No. 60/970,843, filed on Sep. 7, 2007.

(51) Int. Cl. G06F 15/173

(52) U.S. Cl. 709/224

(57) ABSTRACT

A common poller polls multiple network devices of a communication network regardless of device type. A device personality service associates information corresponding to each of the devices with unique identifiers thereof. The common poller provides information resulting from polling the devices to network management systems (“NMS”) that request status and health information thereof. A poller client interface isolates the NMS from a common datastore coupled to the common poller and processes the information between the datastore and the NMS so the datastore is not directly exposed to the NMS. A scheduled poller causes the common poller to poll each network device according to a predetermined schedule. An on-demand poller may poll the devices between scheduled polling events. If a predetermined period as not passed since previous scheduled polling, the poller client interface forwards previously stored information from the common datastore to an NMS requesting status for a given device.

### CROSS REFERENCE TO RELATED APPLICATION

This application claims priority under 35 U.S.C. 119(e) to U.S. provisional patent application No. 60/970,843 entitled “System and method for dynamic polling of network devices,” which was filed Sep. 7, 2007, and is incorporated herein by reference in its entirety

### TECHNICAL FIELD

The claimed subject matter relates to communications networks, and more particularly, to monitoring of a variety of network devices coupled to a network, including wireless and wired subscriber's devices, and even central network devices that communicate with the network.

### BACKGROUND

System performance and scalability are essential in a next generation operating system services (“OSS”) as the content service providers (“CSP”) internet protocol (“IP”) networks and services evolve, and their subscriber base rapidly expands. The network infrastructure will undergo a period of rapid change spread over a number of years. As the subscriber base grows the number of devices and different types of devices that a given network supports will grow accordingly.

As this network transition to IP evolves, it will require new types of devices, or new flavors of existing devices, to provide ‘Triple Play’ and ‘Quadruple Play’ services. This includes cable modems, digital subscriber line access multiplexer (“DSLAM”), residential gateways, set top boxes, session initiation protocol (“SIP”) servers, media gateways, policy servers, session border controllers, video servers, Ethernet switches, etc.

With the proliferation of literally millions of devices throughout the network footprint, a considerable amount of replication of functionality occurs in interfacing to these devices. For example, each vendor's element management system (“EMS”) periodically polls its devices to perform auto-discovery of new devices, test reachability, or availability, (up/down status), round-trip response times, interface health status, and to gather MIB metrics. The same polling function is being carried out by fault management (“FM”), performance management (“PM”), network management system (“NMS”) and service assurance OSSs in the operations center.

In addition to the network resources that are wasted with this uncoordinated and sometimes duplicate polling, each system like NMS is storing the data in its own database, with different ways to access this data externally. In addition, NMS pollers typically do not take into account the network topology in order to localize polling to avoid costly WAN traffic whenever possible. This is depicted in the following diagram shown in FIG. 1.

FIG. 1 illustrates polling of managed devices in a communication system 2. Network management servers 4 A-C communicate with managed devices 6 over network 8. Typically, applications running on servers 4 poll devices 6 and store results to databases 10 that correspond to servers 4. Channel lines 12 represent a data path, which may be a separate frequency, or other multiplexing type, of channel. As shown in the figure, eighteen channels may be used to poll the six devices 6 shown in the figure when management servers 4 poll all of the managed devices simultaneously. Since the management servers 4 and the managed devices 6 transmit and receive polling information over network 8, they use quite a bit of network resources, bandwidth, for example, when performing the polling tasks. Thus, a need exists in the art for reducing the amount of network resources used to poll managed devices 6 when monitoring the health and status of network devices, decreasing traffic load on network devices, and reducing the need to replicate and store data stored in multiple locations.

### DESCRIPTION OF THE DRAWINGS

FIG. 1 illustrates a system for multiple management servers polling multiple managed devices over a communication network.

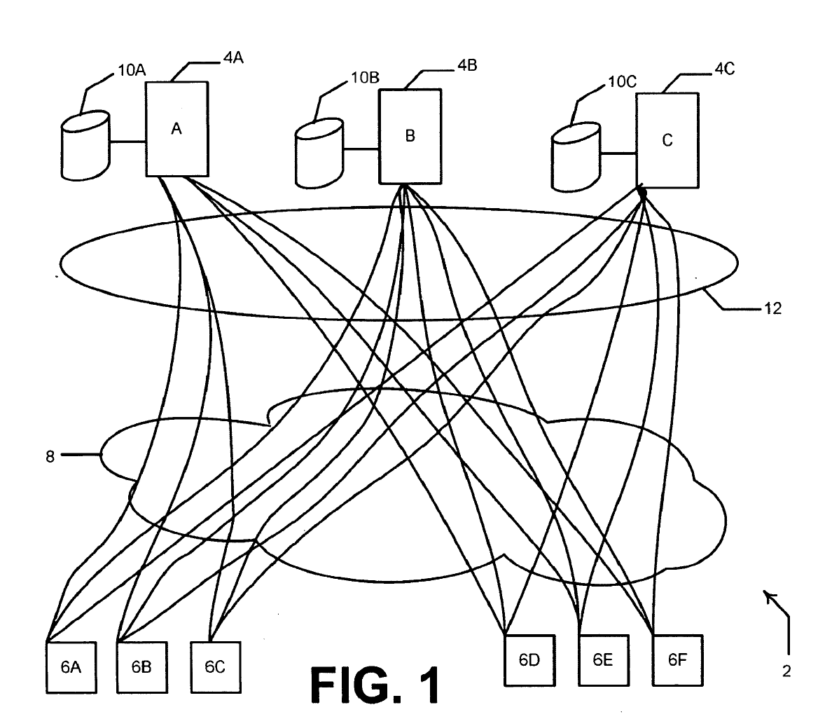

FIG. 2 illustrates a system for multiple management servers polling multiple managed devices over a communication network using a device personality service application.

FIG. 3 illustrates a flow diagram of a method for using the common polling server components device personality, scheduled poller and on-demand poller for polling multiple devices.

### DETAILED DESCRIPTION

As a preliminary matter, it will be readily understood by those persons skilled in the art that the present invention is susceptible of broad utility and application. Many methods, embodiments and adaptations of the present invention other than those herein described, as well as many variations, modifications, and equivalent arrangements, will be apparent from or reasonably suggested by the present invention and the following description thereof, without departing from the substance or scope of the present invention.

Accordingly, while the present invention has been described herein in detail in relation to preferred embodiments, it is to be understood that this disclosure is only illustrative and exemplary of the present invention and is made merely for the purposes of providing a full and enabling disclosure of the invention. The following disclosure is not intended nor is to be construed to limit the present invention or otherwise to exclude any such other embodiments, adaptations, variations, modifications and equivalent arrangements, the present invention being limited only by the claims appended hereto and the equivalents thereof.

A common polling system will eliminate or minimize redundancies and reduce overhead loading of network resources. Devices may be hardware or software based. Software probes running on general purpose servers, dedicated probes or on devices performing other functions in the network, i.e. switches, are potential sources of information that may need to be polled on a regular basis. The invention will provide this capability.

Another aspect is extensibility to connect to new types of devices or new devices within a pre-existing device group. CSPs are usually hesitant to deploy single source elements in their network and will commonly look to have more than one vendor supplying key devices. The ability to efficiently add new types of devices or new devices from different vendors is a critical capability.

Service providers desire access to the management data for all of their devices through one API. Another problem that the common polling system will solve is the difficulty in altering the polled information, either to add additional data to an existing device, or simply to change polling intervals. Currently, each NMS polls only the data set it is interested in for the devices it manages. A common polling system will facilitate service providers in add or editing new types of devices in the system easily, adjust the intervals of data collection in a flexible and consistent way, and provide access to that data via a common interface.

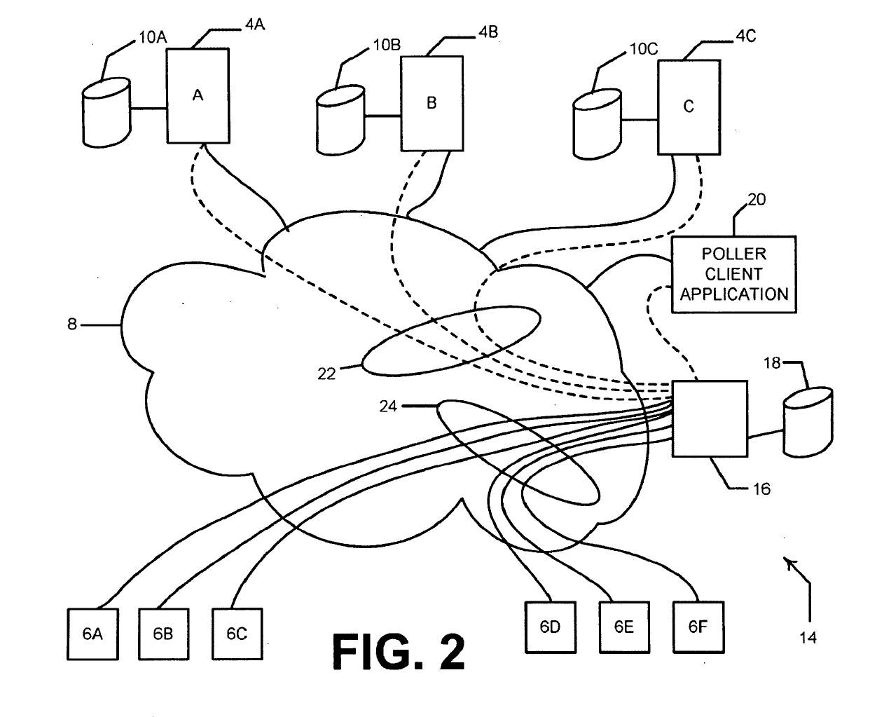

Returning now to the figures, FIG. 2 illustrates a common polling system that uses a consolidated enterprise NMS application architecture. System 14 provides polling results from multiple devices 6, of various types, to multiple network management servers 4 over communication network 8. Common polling server 16 couples to network 8 and stores polling information to common polling data storing system 18; system 18 may also be referred to as a networkable datastore that includes a computer storage means such as a hard drive, tape drive, optical drive, etc., processors, memory, and other structural components known in the art that work as a system used to store computer information and data. Common polling server 16 provides information from common datastore 18 over network 8 to management servers 4 under through poller client interface 20. It will be appreciated that poller client 20 does not directly poll devices. Rather, it provides an external interface to the common poller server 16 so that servers 4 do not access the common polling datastore 18. Thus, the underlying common polling datastore 18 is never publicly exposed. It will be appreciated that poller client 20 may be implemented as a software application. Alternatively, poller client 20 may be implemented in hardware, such as, for example, with a field programmable gate array device, or with a microprocessor.

Common poller 16 includes sub components, including personality client 16A, scheduled poller client 16B and on-demand poller 16C. The device personality client 16A may be thought of as a Device Definition Dictionary, which can discern a device's identifier, from which it can determine the corresponding device's protocol, or protocols, used for communication, as well as other information that is useful for facilitating communication with, and information that the device can provide to, another device over communication network 8.

Device definition dictionary 16A in the common polling server 16 facilitates device management. Device Personality component 16A associates a devices type with one, or more, communication protocols it may use to communicate over network 8. Device Personality component 16A also associates information that a device may be capable of reporting to management servers 4. Device Personality component 16A may associate less than all of the information a device 6 may be capable of reporting. Device personality component 16A may also include an association between a device's unique identifier, for example a Media Access Control (“MAC”) address. It will be appreciated that device personality component 16A may store its information internally (i.e., the device definition dictionary may include a software component and a hardware storage, or memory, component), or the device personality component may store its data on datastore 18 and access it to read data therefrom.

One may also refer to device personality service client 16A as a device definition dictionary that defines a collection of classes that represent device types. These device type definitions describe the data that is available for a particular kind of device. This data may be exposed through different kinds of access protocols, such as simple network management protocol (“SNMP”), TL1, or SOAP. Generally speaking, each access protocol will contain their own definitions that define the data points that are available through that access protocol, along with any configuration values used to communicate with the device to obtain the data point values. For example, with SNMP data, a device type may define all of the different management information base (“MIB”) objects needed from that type of device, along with SNMP security, timeout, and failure parameters to use when retrieving that data. The design of the device type definition allows for the inclusion of other types of data accessed through other access technologies in the future.

In addition to the classes representing these device definitions, device personality service 16A provides a common interface to persist and retrieve these definitions to and from network management systems. This is needed because this service will be used in different contexts and applications, each potentially requiring their own unique persistence strategy. For example, this poller application will need the ability to store and retrieve definitions from its database, as well as read definitions from XML files. Other applications may need to store and retrieve from XML files or other types of data stores. The design will therefore include a persistence interface used by the service to generically load and store the data definitions so client code can use the service without being tied to one underlying persistence strategy.

Scheduled poller component 16B, which is included in common polling server 16, allows for polling a device according to a predetermined schedule. Personnel of the operator of network 8 may specify and alter the polling interval as needed.

A component is the ManagedDevice, which represents a physical device that can be communicated with through the various Access Protocols defined by the Device Personality service's device types. A ManagedDevice typically defines an IP address used for communicating with the physical device. The class also defines a unique name, which for most managed devices will be the MAC address; in the case of devices without a MAC, this can be an arbitrary string, so long as it is unique.

A ManagedDevice also has an id attribute, used for database persistence. An optional DeviceType can be defined, once a managed device is given a device type it has the ability to make use of the device personality definitions to create polling contexts and connection info objects for polling. A ManagedDevice can be used for polling prior to a device type being set (for instance during device type discovery), by client code creating appropriate ConnectionInfo and PollContext objects. The ManagedDevice class defines an asynchronous poll method, which takes a named PollContext instance representing Access Protocol-specific data points, along with a callback object. This asynchronous method delegates to a PollStrategy instance with the same name as the supplied PollContext, to communicate with the physical device through the named Access Protocol. Because clients will need to be alerted that a poll with a physical device is complete, a callback object is supplied to the poll method to report back success or failure. In this manner, a ManagedDevice can communicate with a physical device through an arbitrary Access Protocol.

An AccessInfo interface encapsulates access-specific attributes, data, and state and status for the access protocols. Status is provided at the access protocol level so that a device that isn't responding, or is responding improperly to one access protocol can be polled less frequently, or in a less-heavyweight manner, to conserve system resources, without affecting other access protocols that the managed device responds to. The ManagedDevice class provides a getStatus method which returns an overall status for the device based on the status of the various constituent access protocols. A ConnectionInfo interface is mostly a marker interface that provides a unique name for its Access Protocol. ConnectionInfo implementations provide all of the security and connection information required for communication with a physical device through a particular Access Protocol.

On-Demand poller 16C in the common polling server 16 facilitates polling the managed devices in response to a specific request to poll one, or more, devices. Network operations personnel may refer to such a specified polling of one or more devices as ‘on demand’ polling.

Common polling server 16 achieves a reduction in bandwidth used over network 8 for polling and monitoring because the polling server 16 stores polling results to datastore 18 after a first network management service system (“NMS”), for example 4A, polls a device. When a second NMS, for example 4B, tries to poll the same device, polling server 16 returns the previously polled and stored data instead of repolling the same device 6 again.

Common polling server 16 may further manage polling bandwidth usage by instructing scheduled poller component 16 B to report recently scheduled polling information for a given device instead of actually performing another polling operation in response to an on demand polling request. Personnel operating network 8 may specify the amount of time following a scheduled polling operation that server 16 may respond to an on demand request with stored information from the scheduled polling operation.

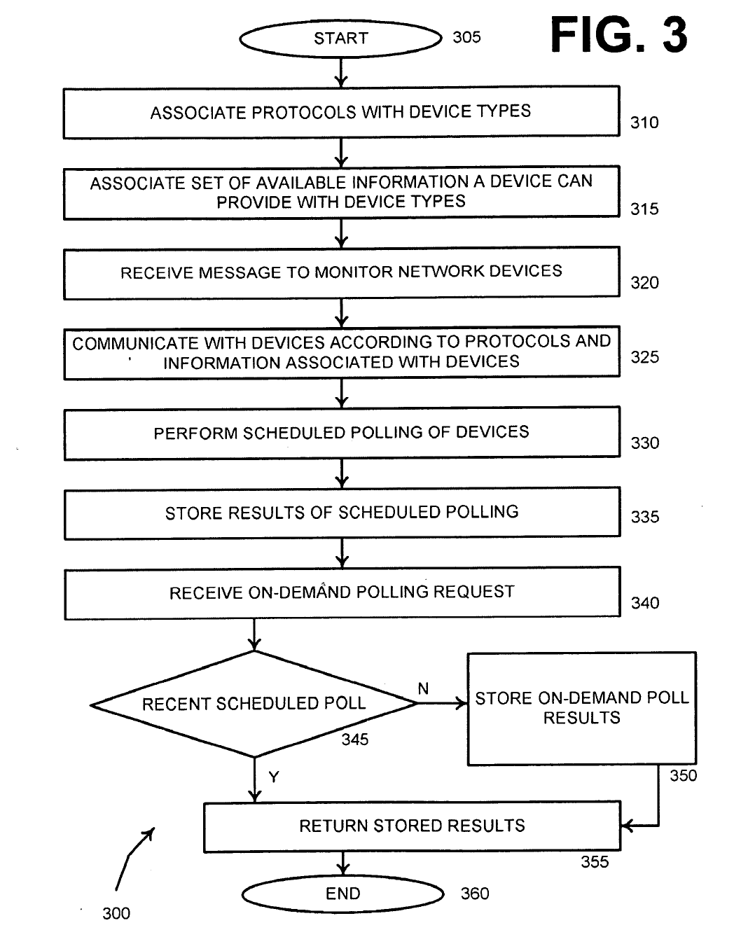

Turning now to FIG. 3, the figure illustrates a method 300 for reducing bandwidth usage in polling multiple devices of a variety of device types over a communication network. It will be appreciated that method 300 need not perform the steps illustrated in the figure in a sequence corresponding to the reference numbers shown in the figure. Method 300 starts at step 305 and associates one or more communication protocols with each of various types of devices that may be managed over the network at step 310. At step 315, method 300 associates a set of information that a device can provide with that devices device type. All of this is facilitated through the device personality service component. One skilled in the art will appreciate that a device can provide a suite of information, and the set associated with the device's type may be less than the all of the information a device can provide.

Continuing with description of method 300, the method receives a message to monitor network devices at step 320. The message to monitor devices may be an on demand request to monitor, or a scheduled request to monitor from one or more device management servers. Upon receiving a request to monitor, the common polling server, or application, facilitates communication with the managed devices according to the protocol associated with the device's type as defined by the device personality component at step 325. The common polling server may direct that a scheduled poller component store information returned from the monitored devices to a common datastore.

Continuing with describing method 300, a common polling service (which the personality service may include) may cause a polling server to perform scheduled polling of the managed devices at step 330 and then cause the polling server to store polling results to a common polling datastore at step 335. At step 340, the polling service may receive an on demand polling request. The polling service then determines at step 345 whether a predetermined amount of time has passed since the scheduled polling performed at step 330. If the predetermined amount of time has passed, the polling service deems at step 345 that scheduled polling has not been performed recently, and stores the on demand polling results to the common polling datastore at step 350. The polling service then causes the common polling server to report the stored results for the monitored devices to device management servers at step 355. If the polling service determines at step 345 that scheduled polling has recently occurred, then the service causes the polling server to skip step 350 and report stored information to one, or more, of the management servers at step 355. Method 300 ends at step 360.

The following lists some acronyms used herein and what they refer to.

### ACRONYMS

### OSS—Operating System Services

### CSP—Content Service Providers

### IP—Internet Protocol

### DSLAM—Digital Subscriber Line Access Multiplexer

### SIP—Session Initiation Protocol

### FM—Fault Management

### EMS—Element Management System

### PM—Performance Management

### NMS—Network Management System

### WAN—Wide Area Network

These and many other objects and advantages will be readily apparent to one skilled in the art from the foregoing specification when read in conjunction with the appended drawings. It is to be understood that the embodiments herein illustrated are examples only, and that the scope of the invention is to be defined solely by the claims when accorded a full range of equivalents.

What is claimed is:

1. A method for automatically polling network devices of various types, comprising:
associating one, or more, of a plurality of communication protocols with each of the device types;
associating a set of available information a device can provide with each of the device types;
receiving a message to monitor the network devices, wherein the message includes device type identifiers of the network devices; and
communicating with one, or more, of the devices according to the one, or more, protocols and information associated with the one, or more, devices being communicated with.

2. The method of claim 1 further comprising:
performing scheduled polling of the network devices with a common polling server;
storing the results of the scheduled polling to a common polling database; and
reporting the stored results to one, or more, management servers requesting status or health information for a given network device.

3. The method of claim 2 further comprising:
receiving an on demand polling request;
determining whether a predetermined period has passed since the most recent scheduled polling was performed; and
reporting the results stored from the most recent scheduled polling operation to one, or more, management servers assigned to the polled devices if the predetermined amount of time has not passed.

4. The method of claim 2 further comprising:
receiving an on demand polling request;
determining whether a predetermined period has passed since the most recent scheduled polling was performed;
performing a polling operation in response to the on demand polling request; and
reporting the results of the on demand polling operation to one, or more, management servers assigned to the polled devices if the predetermined amount of time has passed.

5. A system for polling a plurality of communication devices of multiple device types over a communication network, comprising:
a common polling server for facilitating polling of one or more of the plurality of devices of one, or more, of the multiple device types and providing results that result from the polling to components of one, or more, network management system;
a common polling datastore for storing information that results from the polling of the one or more devices; and
a poller client interface, coupled to the network, that provides an interface between the common polling server and one, or more, of the network management systems.

6. The system of claim 5, wherein the common polling sever includes a device personality service capable of receiving information from, and providing information to, the communication network and devices in communication therewith.

7. The system of claim 6 wherein the device personality service associates information corresponding to each of the one or more devices with a unique identifier of the device.

8. The system of claim 7 wherein the common polling server includes a scheduled poller and an on-demand poller.

9. The system of claim 5 wherein the poller client interface couples to the network and includes software for processing communication between the network management systems and the common polling server.

10. The system of claim 5 wherein the poller client interface couples to the network and includes hardware for processing communication between the network management systems and the common polling server.

11. A system for polling a plurality of communication devices of multiple device types over a communication network, comprising:
a common polling server for facilitating polling of one or more of the plurality of devices of one, or more, of the multiple device types and providing results that result from the polling to components of one, or more, network management system; and
a common polling datastore for storing information that results from the polling of the one or more devices.

12. The system of claim 11, further comprising a poller client interface, coupled to the network, that provides an interface between the common polling server and one, or more, of the network management systems.

13. The system of claim 11, wherein the common polling sever includes a device personality service capable of receiving information from, and providing information to, the communication network and devices in communication therewith.

14. The system of claim 13 wherein the device personality service associates information corresponding to each of the one or more devices with a unique identifier of the device.

15. The system of claim 11 wherein the common polling server includes a scheduled poller and an on-demand poller.

16. The system of claim 12 wherein the poller client interface couples to the network and includes software for processing communication between the network management systems and the common polling server.

17. The system of claim 12 wherein the poller client interface couples to the network and includes hardware for processing communication between the network management systems and the common polling server.
